(19) United States
(12) Patent Application Publication
(10) Pub. No.: US 2014/0087238 A1
(43) Pub. Date: Mar. 27, 2014

(54) BATTERY PLATE WITH MULTIPLE TABS AND MIXED PORE DIAMETERS

(71) Applicants: Kurtis C. Kelley, St. George, ME (US); Mukesh Bhandari, Gujarat (IN); Mathew Stone, Peoria, IL (US)

(72) Inventors: Kurtis C. Kelley, St. George, ME (US); Mukesh Bhandari, Gujarat (IN); Mathew Stone, Peoria, IL (US)

(73) Assignee: Firefly International Energy Group, Inc., Peoria, IL (US)

(21) Appl. No.: 14/001,378

(22) PCT Filed: Feb. 23, 2012
(86) PCT No.: PCT/US12/26350

§ 371 Date: Nov. 14, 2013

Related U.S. Application Data
(60) Provisional application No. 61/446,403, filed on Feb. 24, 2011.
(60) Provisional application No. 61/535,434, filed on Sep. 16, 2011.

(51) Int. Cl. H01M 10/10

(52) U.S. Cl. CPC H01M 10/10
USPC 429/160; 429/209; 429/231.8; 429/302; 429/303; 429/300

(57) ABSTRACT

A battery electrode assembly comprises a porous electrode plate having a plurality of large and small pores, a pore insert within a plurality of pores, the pore insert maintaining an electrolyte in the pores substantially throughout a discharge/charge cycle. The pore insert may be a gelled electrolyte. The pore insert may be a particulate material. The electrodes may be used in a battery having cells with opposing positive and negative tabs connected in series by an intercell connector.

### CROSS REFERENCE TO RELATED APPLICATIONS

This application is a U.S. National Phase Application of International Application No. PCT/US2012/26350 filed Feb. 23, 2012, which claims priority to U.S. provisional applications 61/446,403 filed Feb. 24, 2011 and 61/535,434 filed Sep. 16, 2011, and both of which are incorporated herein by reference.

### BACKGROUND OF THE INVENTION

1. Field of the Invention

The present invention is in the field of lead acid batteries, and in particular the arrangement of tabs for multi-cell lead acid batteries and also batteries having multiple pore sizes, and methods of manufacturing the same.

2. Related Art

Traditionally, valve-regulated lead acid (“VRLA”) batteries have positive and negative plates each plate having at least one tab, which plates are separated using a separator, surrounded by electrolytic material and sealed to make the battery, with tabs of varying numbers located in various arrangements, which tabs are connected to one or more busbars, which busbars are connected to positive and negative terminals. In a traditional design, the electroactivity between the plates and electrolyte is uneven, with some areas having high electroactivity and some low. Areas of low electroactivity do not produce power and are thus undesirable.

In efforts to create a battery that is more efficient and less expensive to manufacture, the number and placement of tabs and the assembly of plates in the battery case have been improved upon by many inventions. “Opposing tab” batteries were invented in an effort to improve the efficiency of VRLA batteries. In opposing tab batteries, the electrical connections to the positive and negative plates are made on opposite sides of the battery.

One example of an opposing tab, 2-cell battery, is known in the art as the Horizon structure. It has cells in a row, all with the same orientation, and the negatives of one cell connected to the positives of the adjacent cell by cables. This battery presented potential drawbacks such as shorts from loose conductive fibers, intercell leaks and negative grid corrosion. Another opposing tab battery is described in the specification of U.S. Pat. No. 6,815,118 B2, where each plate has at least one tab on a first side of the plate, and at least one tab on a second side of the plate. Each tab is connected to a busbar to form positive and negative busbars on each of the first and the second sides of each plate. This design, however, is difficult to manufacture. Such designs are sensitive to the length of the cabling needed to connect the terminals since terminals are arising from both ends of the battery. The end that needs the longest cable will have a higher resistance path and thus negate much of the improvement in electroactivity between the plates.

While promising, opposing tab batteries also proved to be more costly to manufacture due to the complexity of the connections, which in turn required more complex battery cases with a greater number of the seals that are required for a sealed lead acid battery. In general, traditional opposing tab batteries may suffer from one or more of the following problems:

1. The battery terminals are on opposite sides of the battery making connection difficult;

2. Terminals on opposite sides of the battery make sealing more complex because of the increased complexity of the case;

3. Efforts to route the battery terminals to the same side of the battery greatly increases cost, size, and weight;

4. Opposing terminal batteries have required an investment in new equipment specific to their processing;

5. Battery terminals on opposite ends of the battery are non-standard, making the end-user also invest in new racking system design; and

6. Opposing tab batteries have only been for individual 2V cells, which increases cost to higher voltage systems.

Accordingly, there is a need for an improved opposing tab battery that is easy to manufacture and improves upon prior traditional and opposing tab lead acid batteries with respect to cost to manufacture, efficiency, battery life, sulfation, corrosion and electrolyte stratification. Moreover, it would be useful to have a 4 Volt, 2-cell battery that weighs less and is easier to manufacture than conventional batteries; that has fewer terminal posts and less cabling than conventional 2-cell batteries; has no internal cells; that has tabs designed to minimize connection length and that result in terminals arising from the same side of the battery case, and utilizes a battery case cast as a single piece plus a lid.

### Pores

It is known to increase battery performance by using electrodes made of a porous material such as carbon foam or graphite, which advantageously increases the surface area on which electrochemical reactions take place. In order to realize these advantages, the batteries' active material, which may be electrolyte, must be within the material's pores.

A pore here is defined as an opening of any configuration and dimensions which, if reduced to an ideal tube shape, would have a diameter and length. The diameter (minor diameter) is a close approximation of the average minor distance between rigid structures. The length of the pore is the longest continuous connection of open space and is not necessarily a straight line. This is very similar to particle size descriptions, which often describes a particle as a sphere regardless of shape.

Lead-acid batteries now use small pores, and great effort (both process and chemistry) is put into mixing active-material that is packed around the electrode to create this small network of pores. When a traditional battery discharges, the electrolyte inside the plate is consumed in the reaction first. Further discharge requires that more electrolytes enter the plate from the separator to react. The separator is treated as a reservoir for electrolytes in the lead acid battery. This prior art reservoir concept has two relevant effects here: first, the separator must be thick enough to hold electrolyte sufficient to react and deliver good capacity, which causes a greater separation between plates and increases the distance that ions need to travel, slowing the charge and discharge reactions. Second, the discharge reaction is forced to occur first on the active-material in the plates that is closest to the reservoir. This reaction is the creation of lead sulfates, which are quite large and tend to block the movement of more electrolytes deeper into the plates. This well known surface sulfation problem is familiar to the layman as the tendency of auto batteries to crank the engine well on a first start attempt, followed by progressively weaker cranking by the battery with further start attempts if the engine does not start at first.

The ability to refill an emptied pore with electrolyte via capillary attraction is a function of surface-energy, pore diameter, and electrolyte surface-tension. Electrolyte surface-tension and material surface energies are difficult to modify without adversely affecting battery function. Pore diameter may be kept small in PbA batteries by adjusting the density of the active material packed into an electrode.

The amount of electrolyte is directly linked to the amount of capacity that the battery has. Large pores would allow a greater amount of electrolyte to be in close proximity to the active material in the battery plates, if electrolyte could be effectively retained in them.

It was believed from past experience with gel electrolytes in batteries discussed in publications, that the gel particles create a tortuous path that slows ion-mobility between plates, and that this reduces high-rate discharge capacity considerably from non-gelled-electrolyte batteries. “Gel Cell Batteries do not offer the same power capacity as do the same physical size AGM battery. However, the Gel Cell excels in slow discharge rates and slightly higher operating temperatures and with excellent deep cycle capability.” from http://www.atbatt.com; “Gel is an older technology than RBSM technology for valve regulated lead acid batteries: gel batteries have been around for many years but have not been widely used except for special applications. The gel system has an inferior performance at high discharge rates, therefore it is not suitable for applications such as SLI requiring a high rate discharge capability.” From: A guide to VRLA Battery Formation Techniques by Mike Weighall and Bob Nelson; “ABSORBED GLASS MAT BATTERIES: These are state of the art batteries. The acid is suspended in a special glass mat that overcomes the ion mobility problems associated with gels and in fact accelerates ion mobility to a level far better than flooded batteries.” From Outback Marine Australia PTy Ltd battery manual, 2002; “In true Gel Cells, the sulphuric acid electrolyte is thickened (gelled) to allow the battery to work in all positions. Unfortunately this electrolyte thickening decreases the mobility of the ions which results in increased internal resistance.” From Oddmix.com.

The electrolyte in these large, open-pores can be driven out by gassing during normal battery charging or by normal drying forces. Battery plates with a substantial number of large open pores, larger than about a 50 microns minor diameter, have difficulty retaining electrolytes in the large pores. Even if initially filled with electrolytes, once the pore is emptied thru gassing or drying, there is generally insufficient capillary attraction to refill the pore. Once dry they are unlikely to refill. And once empty, battery capacity tends to drop.

### SUMMARY OF THE INVENTION

### Tabs

The invention is an improvement to traditional 4V, 2-cell lead acid batteries, in that the tab location and cell arrangement within the battery of the invention permits serial connection of the 2 cells within the battery case and the terminals arising from the same side of the battery, where the negative tabs of one cell are on the same side as the positive tabs of the other cell (see FIG. 1b). This design is easier to manufacture than most opposing tab battery designs and forces uniform electroactivity across the battery plates, which results in an increased capacity and battery life with reduced sulfation, corrosion and electrolyte stratification within the battery. Also described is a method of manufacture of the battery of the invention.

A 4 volt, 2-cell VRLA battery with opposing tabs is disclosed, with each cell comprising a positive plate with one tab, a negative plate with one tab, and a separator, wherein the plates in each cell are assembled such that the separator is disposed between the plates and the tabs are arranged on opposite sides, with the cells connected in series and arranged within a battery case such that the terminals are located on the same side of the battery.

### Pores

The invention places a large amount of electrolyte into the plates themselves, rather than in the separator as part of the carbon foam concept. The invention uses a plate having an open electrode structure, like a carbon foam, with a composite structure that attracts and retains electrolyte in the pores. The separator area has a strong attraction for the electrolyte, particularly in gel or AGM batteries. The invention balances that attraction and retains electrolyte in the plates.

A new class of open-pore PbA plates, such as the open-pore carbon-foam plate from Firefly Energy, has both small and large pores. The small pores are a characteristic of the active material density, and the larger pores are designed to act as reservoirs for electrolyte in close proximity to the active lead materials. The electrolyte in a lead-acid battery is actually an active material itself.

The pores of the invention are within the pores of the carbon foam electrode, which is wash-coated with active material. The invention creates an “interpenetrating network” of two material phases: one is the network of particles that may be connected, and the second is a network of air, which is connected. The air network is displaced by electrolyte when the electrolyte is first added to the battery.

In one embodiment, the current invention circumvents the issue of large-pore-emptying by placing a gelled electrolyte in the pores of the plate. The gel is not able to flow as a liquid and therefore is not displaced from the pore during gassing. Additionally, the gel is more resistant to normal drying than a liquid. The gelled electrolyte has the benefit of retaining close electrochemical communication with both the leady active-material in the battery plates and with the electrolyte retained in and around the separator. (Note: a “gel” in this context is a 3-dimensional structure made up of particles variously attached to each other almost like branching strings of pearls.) The primary particle size can be anywhere from about 1 to about 300 nanometers.

A second design to circumvent the issue of losing electrolyte in the large pores of the plate is to add into the pores a material which reduces the maximum distance between capillary walls. The battery electrode of the current invention may be comprised of an electrode, active material dispersed in and around the electrode, with open pores that are filled with a fibrous or particulate material which effectively reduces the functional pore-size sufficiently to draw in electrolyte via capillary forces. By adding a fine chopped glass fiber, for example, the functional capillary pore diameter is reduced to the distance between any two fibers or between a fiber and the pore wall. An electrolyte can still be evicted from the area through gassing or other drying phenomena, but because the capillary pore diameters are sufficiently reduced, electrolyte will refill those porous areas through capillary attraction with electrolyte from the separator battery area or other reservoir areas. Capillary refill may be substantially immediate. A particulate material, such as precipitated silica, could also be used in place of or in combination with the fibers. Acceptable materials include any structures which effectively maximize pore space while reducing effective pore diameter and can include any natural or man-made silica, polymeric, and ceramic fibers, particles, platelets, whiskers, dendrites, porous spheres and shapes, hollow spheres and shapes, diatoms, pearlite, solid fibers and hollow fibers. The materials may further be variously agglomerated, intertwined, bent, woven, or free. All such materials shall be referred to herein as particulate materials. Particulate materials and gelled electrolyte shall be referred to herein as pore inserts.

With either embodiment, the active electrolyte is maintained in the pores substantially throughout the discharge/charge cycle, and performance improvements are maintained throughout hundreds of discharge/charge cycles.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1 is a picture showing two types of electrode grid arrays—prior art opposing tabs (FIG. 1A) and the opposing tab design of the current invention (FIG. 1b).

FIG. 2(a) is a picture and description of the connections between the cells in the battery of the invention and the process of making the connections and 2(b) depicts inserting the cells into the battery case.

FIG. 3 is a picture and description of how the cells are inserted into the battery case and sealed using the methods of the invention.

FIG. 4 is depiction of an alternative connecting means for connecting the cells of the battery of the present invention.

FIG. 5(a) is a depiction of two cells attached with opposing tabs to form the battery of the invention. FIG. 5(b) further depicts the container walls and inter-cell wall of the 2-cell battery of the invention.

FIG. 6 is a 3-D drawing of the assembled battery of the invention showing the battery case, the connections and one of two cells, as well as the cavity in the battery case for the second cell of the battery of the present invention.

FIG. 7 is a perspective cut away view of a mixed pore size battery electrode of the present invention.

FIG. 8 is a perspective cut away view of an alternative embodiment of a mixed pore size battery of the present invention.

FIG. 9 is a graph of surprising performance increases of the present invention.

### DETAILED DESCRIPTION OF THE PREFERRED EMBODIMENTS

The following description of the preferred embodiment(s) is merely exemplary in nature and is in no way intended to limit the invention, its application, or uses.

### Tabs

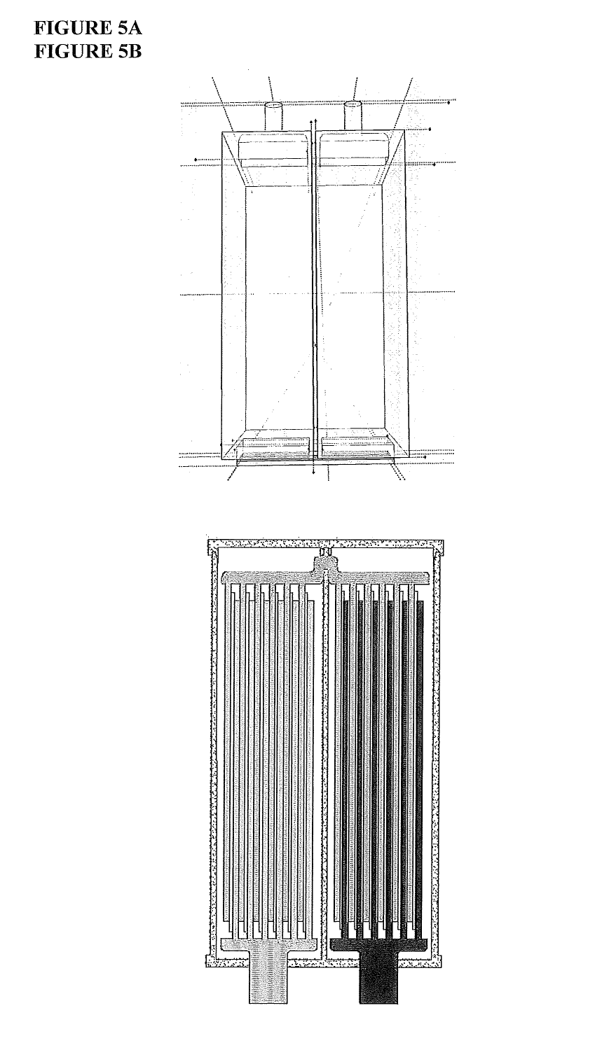

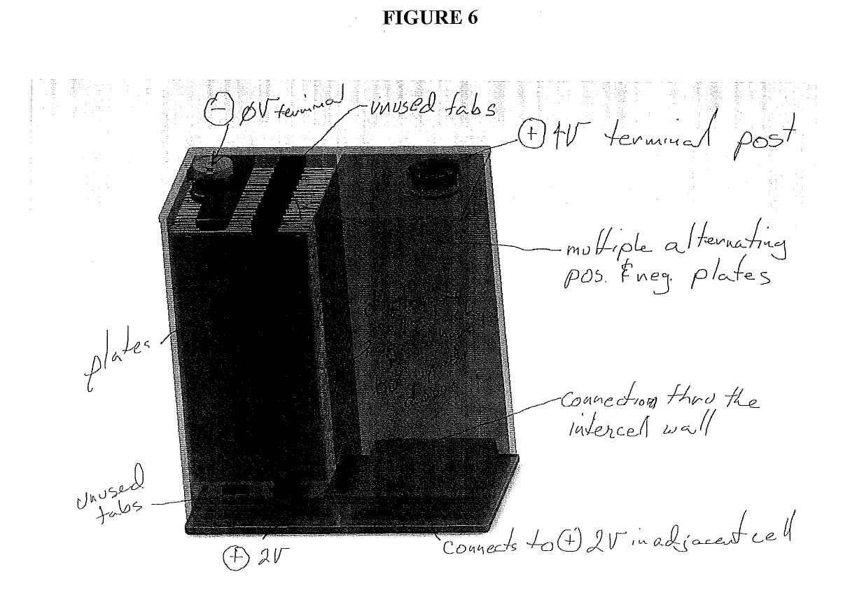

FIGS. 5(a), 5(b) and 6 illustrate and explain the battery of the invention.

FIG. 5a represents two assembled cells 50, 52 (each comprising positive 54 and negative 56 plates separated by a separator 58 that are attached together for each cell, and the cells are arranged with opposing tabs. The two terminal posts 60, 62 (one on each cell) protrude at the bottom. The connection between the cells 64 (the bus) is across the top and is made, in this instance, by a casting lead-metal from the positive tabs of one cell to the negative tabs of the adjacent cell. It is intended that the scope of the present invention will include any method of forming this connection now known or hereinafter devised.

FIG. 5(b) further shows the container walls 66 and inter-cell wall 68, which are manufactured according to standard methods well known in the industry.

FIG. 6 depicts an assembled battery of the invention with one cell removed from the battery container. In the depicted embodiment, the battery of the invention with opposing tabs is built in a 4V (2-cell) arrangement, although the invention may also be applied with a single-cell or higher multi-cell configuration. In the depicted embodiment the two cells with opposing tabs can be assembled, complete with the inter-cell connection, before inserting in the battery container. This creates cost savings and manufacturing efficiencies over traditional 2V designs and methods of manufacture.

The container of the battery of the invention can be molded of only two pieces. The first piece is of all the battery walls plus the “top” of the battery where the posts protrude. The 2-cell plate and tab assembly is slid into this container and the posts are sealed. The bottom “lid” is then affixed and electrolyte added using traditional means. This design and method of manufacture is simpler than that used for traditional batteries and thus has with fewer places for seal failure.

FIG. 6 shows a negative terminal 70, unused tabs 72, pro location of a positive terminal 74 (in Phantom) multiple alternating positive and negative plates 76, a receiver 78 for holding a second cell, a duplicate of cell 80, but installed upside down relative to cell 80, bottom unused tabs 82, bottom 2V tabs 84, an index cell wall 86 (in phantom) and connection 88 through the index cell wall 86, connecting the positive 2V tabs in each all together.

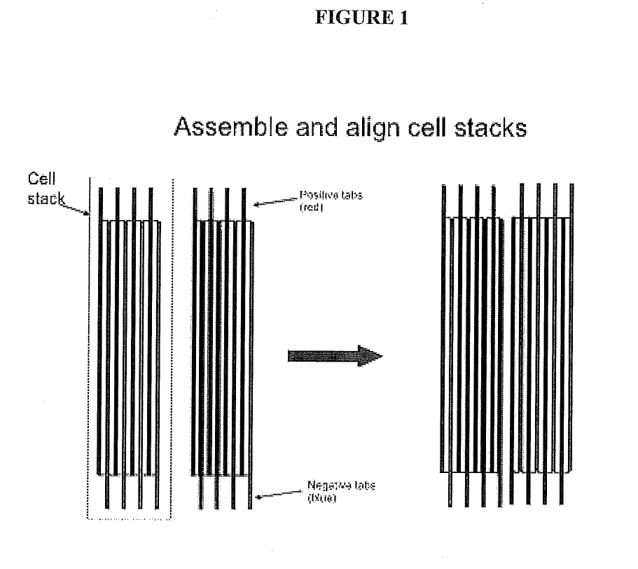

A more detailed depiction of the battery of the invention and method of manufacture is illustrated in FIGS. 1(b)-4. FIG. 1 shows how to stack and align the cells with reference to each other. Two identical cells are stacked with identical components. Tabs are opposing—the positive tabs 100 are on one side and the negative tabs 102 on the opposite side of the cell stack.

One cell is flipped end to end. Now the cells are side by side, but the negative tabs 102 of one cell are on the same side as the positive tabs 100 of the other. Note that in FIG. 1(b), the negative tabs of one cell are opposing and on the same side of the battery case as the positive tabs of the other.

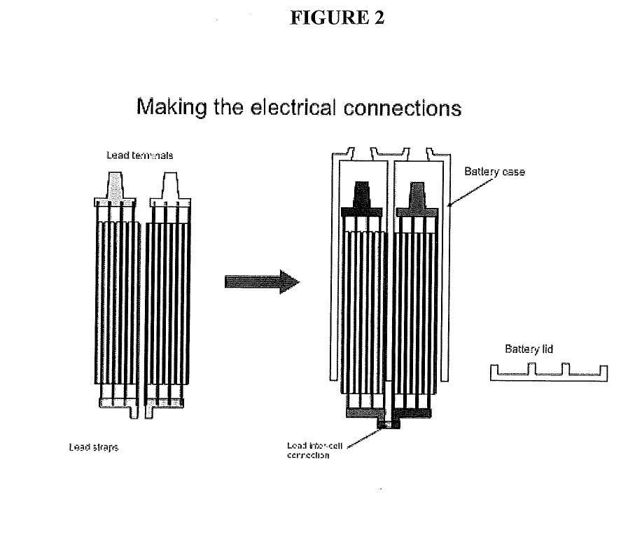

FIG. 2(a) depicts the steps of affixing the straps 104 and terminals 106 onto each cell. Lead straps are cast on the bottom of each cell individually, connecting the tabs.

In FIG. 2(b), the inter-cell connection is formed. Lead terminals are cast on the top of each cell individually, connecting the tabs. The inter-cell connection 108 is cast of lead to connect straps from the two cells and the linked cells are slid into the battery case 110.

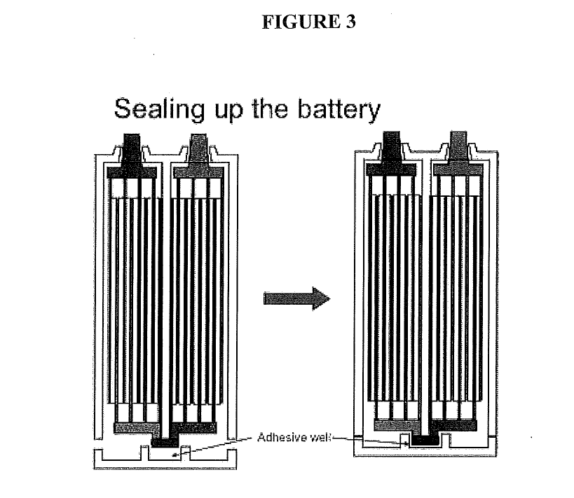

The terminals are sealed, as shown in FIG. 3. The connected, two cells are pushed the rest of the way into that battery case 110, creating a seal at the terminal end where the terminal posts slip into mating sockets 112 molded into the battery case. Adhesive is added to the “adhesive well” and suitable adhesive is applied to the battery case rims. The lid 114 of the battery is attached. Electrolyte is added through a valve opening cast into the casing at either end of the battery, followed by insertion of the pressure-valve, according to methods well known in the art. The lid is adhered to the battery case, sealing the cells from the outside world and from and from each other except for the single short intercell connector.

The plates and electrolyte may be of any composition now known or hereafter invented that is compatible with lead acid batteries. For example, the plates may be foam pasted with lead paste instead of the more traditional lead plates; one example of such foam plates are described in U.S. Pat. No. 6,979,513 to Firefly Energy. Formulation of electrolyte and filling of batteries is well known in the art.

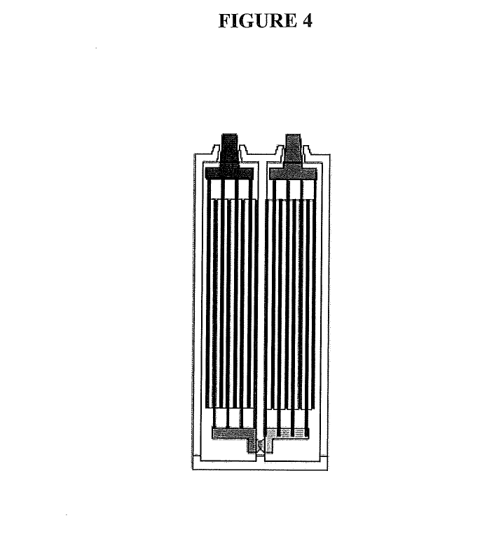

FIG. 4 represents an alternative embodiment of the inter-cell connection integral to the battery case utilizing standard manufacturing methods, wherein the connection 288 passes through the wall of the battery case 210. This inter-cell connection is made by first creating an opening through the cell wall. Portions of the “straps” 204 connecting the plates from each cell are pressed together thru the hole and a high current pulsed is passed between the two straps. Because the resistance in the area that the straps contact is high, heat is generated, melting the lead of the straps, which seals the opening and creates the electrical connection between the cells.

The depicted embodiment of the invention advantageously uses less material, less weight, less costs and a greater efficiency of manufacture because the opposing tabs are integral. The majority of the battery of the invention can be manufacturing using traditional equipment and process steps making the battery of the invention efficient to manufacture.

The depicted embodiment of the invention advantageously avoids the complexity and expense of combining single cell 2V modules for a 4 cell battery by eliminating a pair of terminal posts and inter-cell cabling to put them in series. The depicted embodiment of the invention advantageously avoids of multicell battery problems arising from internal cells operating in different environmental conditions than external cells. The opposing tab design of the depicted embodiment, with both terminals arising from the same face of the battery, provides for shorter connections and less expensive manufacture than batteries with terminals arising from different faces. In the depicted embodiment of the invention “top” (terminal side) of the battery case can be cast as a single piece with the case walls.

### Pores

The current invention circumvents the issue of large-pore-emptying by placing a pore insert into an open pore electrode. The open pore electrode may have mixed pore sizes in it. In one embodiment, the pore insert is a gelled electrolyte. The gel is not able to flow as a liquid and therefore is not displaced from the pore during gassing. Additionally, the gel is more resistant to normal drying than a liquid. The gelled electrolyte has the benefit of retaining close electrochemical communication with both the leady active-material in the battery plates and with the electrolyte retained in and around the separator. The gel structure which retains electrolyte may be composed of any gelling material or additive and includes silica, polymeric gels, metal oxide and salt gels, sulfate gels, clay gels, bentonite gels, and other gelating materials known to those skilled in the art. A gel in this context may be a 3-dimensional structure made up of particles variously attached to each other forming dendric structures. The primary particle size can be anywhere from about 1 nanometer to about 300 nanometers.

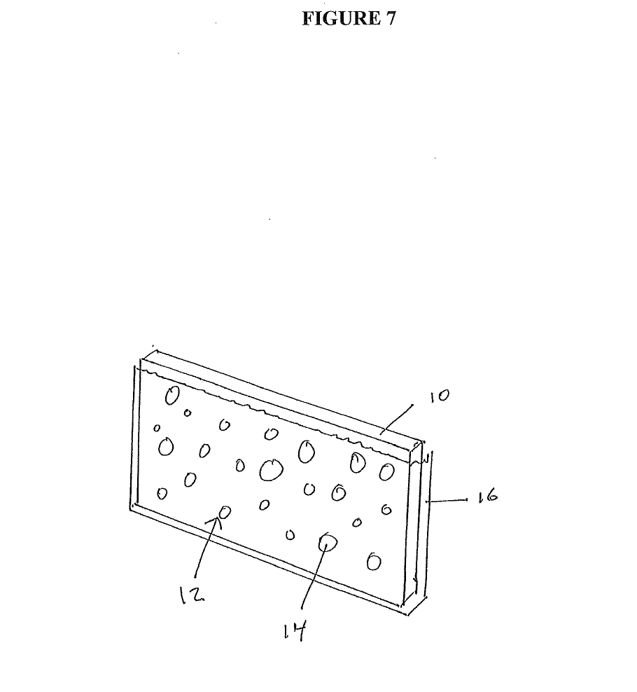

FIG. 7 depicts an electrode 10 having small pores 12 and larger pores 14 in a gelled electrolyte 16. Open volume in this open-cell-foam like structure can be from 60% to 99.9%.

The current invention may include a battery plate comprised of an electrode, active material dispersed in and around the electrode, with open pores of both larger (over 50 micons) and smaller (under 50 microns) size. All pores may be filled with a gel or gelled electrolyte in one embodiment. The gel comprises a large pore fill material or pore insert. The large pore fill material may be an aerogel or xerogel, or any structure made from them. The gel may be a organic or polymeric. Sodium Polyacrylate may be advantageously used. Polymer gels, like Sodium Polyacrylate, have various molecular sizes, all of which are small enough to plate into the large pores. Generally molecular weights between about 2000 and about 1,000,000 may be used.

The apparent gel volume inside the plate may be from about 5% to about 80% depending on the plate design and active-material loading in the plate. “Apparent volume” is the volume taken up by the entire 3-dimensional structure, or the size the gel “appears” to be. This is different from the volume taken up by the primary particles or molecules alone.

A second embodiment of the invention is a battery plate comprised of an electrode, active material dispersed in and around the electrode, with open pores that are filled with a particulate and/or fibrous material which effectively reduces the functional pore-size sufficiently to draw in electrolyte via capillary forces. To circumvent the issue of losing electrolyte in the large pores of the plate, a material which reduces the maximum distance between capillary walls is added into the large pores. An electrolyte can still be evicted from the area through gassing or other drying phenomena, but because the capillary pore diameters are sufficiently reduced, electrolyte will refill those porous areas through capillary attraction with electrolyte from the separator battery area or other reservoir areas. A particulate material, such as precipitated silica, could also be used in place of or in combination with the fibers. Acceptable materials include any structures which effectively maximize pore space while reducing effective pore diameter and can include any natural or man-made silica, polymeric, and ceramic fibers, particles, platelets, whiskers, dendrites, porous spheres and shapes, hollow spheres and shapes, diatoms, pearlite, and hollow fibers. The materials may further be variously agglomerated, intertwined, bent, woven, or free.

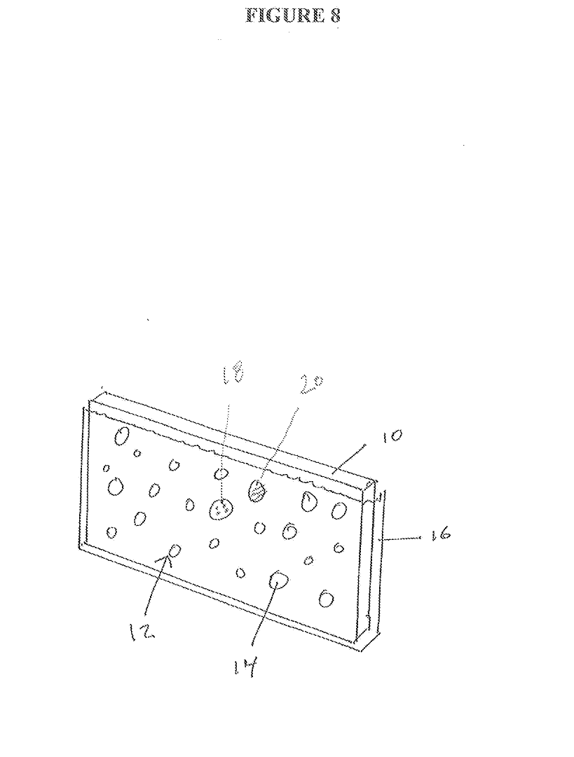

FIG. 8 depicts a second embodiment wherein the larger pores 14 have inculcated in them according at least to the methods described herein particles 18 or fibers 20. A mixed pore size battery having the particulate and/or fibrous pore inserts of the present invention may be expected to realize a capillary refill of electrolyte into the pores that is nearly instantaneous, within one second, after discharging stops.

Particle size can be variable. Dimensions may vary from substantially 30 nanometers to substantially 50 microns. If particles are an agglomerate, the primary particle size can be from substantially 1 nanometer to substantially 5 microns. Particles may be of any shape, including reticulated, star-shaped, or round, may be used.

Where particles are agglomerated, the dimension of the agglomeration may vary from about 200 nanometers at the smaller size. The maximum agglomerate size (or particle size) may be based on the window size of the large pore being filled, for example 50 microns. A foam, which for example may have a window size between pores of 200 microns, is easiest to fill with particles if at least one dimension of the particle is about 1/50th of the window dimension. So, in this case, agglomerates would be broken up to about 4 microns. Any size that fits will work, but using a wash coating process to fill with particles is easiest with this generic formula.

Fiber size can be variable. In one embodiment, fiber size may vary from about 30 nanometers to about 20 microns. Fiber length can vary from about 200 nanometers to about 50 microns.

The dimensions for the particles are important because of the dimensions of the pore structures they create. Capillary attraction is the force which holds the electrolyte in the pores, and the degree of this attraction is directly related to pore diameter. The trade-off is getting the smallest pore size with as little particle volume as possible. Gassing in the battery is itself a strong force in the opposite direction. In general, in the large open pores, to which the particles are added, it is advantageous to create functional capillary pore diameters of about 10 microns or less.

The distance between large pores may be spaced at roughly the thickness of the plate or less to improve active-material utilization. Spacing between large pores may be about ½ the plate thickness and the pore diameters themselves are about ¼ the plate thickness.

Surprisingly advantageous results were have been obtained with the techniques disclosed herein, most distinctively at about 30 nanometers primary particle size that were agglomerated into about 1 to about 2 micron agglomerates. The capacity improvement, at rates faster than 40 hour discharge, were the opposite of the teaching of the prior art. As noted above, it was believed from past experience with gel electrolytes in batteries, that the gel particles create a tortuous path that slows ion-mobility between plates, and that this reduces high-rate discharge capacity considerably from non-gelled-electrolyte batteries. In fact, adding the particles as described herein, including when they create a gel or gel like structure, increases high-rate capacity by about 15 to 20%, which remains stable for many hundreds of cycles (as much as 1300 cycles in testing). Surprisingly, the improvement in retaining electrolyte in close proximity to the active material in the disclosed embodiments outweighs any potential slowing down of ion exchange between plates.

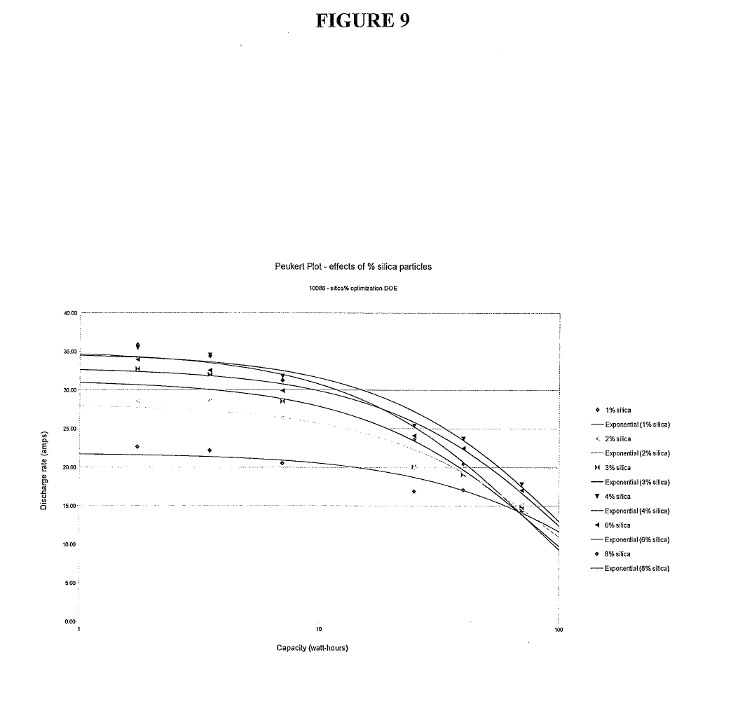

FIG. 9 displays the improved performance of the present invention, contrary to the teaching of the prior art. Output capacity, on the y axis, increase with the addition of one particulate additive in one embodiment of the invention—fumed silicate. (Fuming, well known to those of skill in the art, generally uses liquid silica tetrachloride to produce silica oxide particles which may be about 15 to 30 nanometers in size.) Not only does the output capacity increase by about 50%, but the output advantage is maintained at increased discharge rates of over 10 amps, and does not decrease to levels without the additive until nearly 100 amps. The batteries tested in this data set are identical, except for the silica content, and are rated, without silica, at 25 Ah at the C/20 rate (20 hour discharge), so the 10 amp discharge is equivalent to a C/2.5 rate and 100 amps is equivalent to a 4 C rate.

The techniques of the present invention increase output over the battery's life cycle such that the original output in amps is maintained over 100 discharge/charge cycles and can reach 1000 discharge/charge cycles. This advantageously remains true with even partial recharging. Batteries incorporating the present invention can operate at rated outputs with less than a 100% recharge.

Particles and/or fibers may be inculcated into the pores, particularly the larger pores, according the following method. The particles are suspended in a slurry of roughly 10% volume loaded with particles. The electrode is then is wash-coated, vacuum impregnated, or sprayed into the open pores of the plates, followed by drying. The plates are then handled as normal plates for assembling into batteries. Other methods are within the scope of the present invention. In this manner, particles or fibers enter the pores large enough to receive them. Pores too small to receive the particulates or fibers are small enough to achieve capillary refill on their own.

As various modifications could be made to the exemplary embodiments, as described above with reference to the corresponding illustrations, without departing from the scope of the invention, it is intended that all matter contained in the foregoing description and shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A battery electrode assembly comprising:
a porous electrode plate having a plurality of pores;
a pore insert, said pore insert being within a plurality of said pores, said pore insert maintaining an electrolyte in said pores substantially throughout a discharge/charge cycle.

2. The battery electrode assembly of claim 1 wherein said pore insert is a gelled electrolyte.

3. The battery electrode assembly of claim 1 wherein said pore insert is a particulate material.

4. The battery electrode assembly of claim 3 wherein said particulate material is inserted in a plurality of pores, said pores having a minor dimension of at least about 50 microns.

5. The battery electrode assembly of claim 3 wherein said particulate material that reduces a distance between any two particles or a particle and a pore wall establishes a functional capillary pore diameter.

6. The battery electrode assembly of claim 5 wherein said functional capillary pore diameter had a minor dimension of less than about 10 microns.

7. The battery electrode assembly of claim 1 wherein said porous electrode plate is one of a carbon foam or a porous graphite.

8. The battery electrode assembly of claim 1 wherein said porous electrode plate has larger pores being over 50 micons in a minor dimension and smaller pores being under 50 microns in a minor dimension.

9. The battery electrode assembly of claim 1 wherein the larger pores are designed to act as reservoirs for electrolyte in close proximity to the active lead materials.

10. The battery electrode assembly of claim 1 wherein said pores and said pore inserts increase uniform electroactivity across said battery plate.

11. The battery electrode assembly of claim 1 wherein said electrolyte in a lead-acid battery is actually an active material itself.

12. The battery electrode assembly of claim 3 wherein a primary particle size is from about 1 nanometer to about 300 nanometers.

13. The battery electrode assembly of claim 1 wherein capillary refill may be substantially immediate.

14. The battery electrode assembly of claim 3 wherein said particulate material is at least one of a natural or man-made silica, a polymeric, a ceramic fiber, platelets, whiskers, dendrites, porous spheres, hollow spheres, solid spheres, diatoms, pearlite, fine chopped glass fiber, solid fibers and hollow fibers.

15. The battery electrode assembly of claim 3 wherein said particulate material is agglomerated, intertwined, bent, woven, or free.

16. The battery electrode assembly of claim 2 wherein said gel includes silica, polymeric gels, metal oxide and salt gels, sulfate gels, clay gels, bentonite gels, an organic gel or polymeric gel.

17. The battery electrode assembly of claim 1 wherein said open volume in porous electrode is from about 60% to about 99.9%.

18. The battery electrode assembly of claim 3 wherein said large pore fill material may be an aerogel or xerogel, or any structure made from them.

19. The battery electrode assembly of claim 2 wherein said gel is Sodium Polyacrylate.

20. The battery electrode assembly of claim 2 wherein said gel has a molecular weights between about 2000 and about 1,000,000.

21. The battery electrode assembly of claim 2 wherein said gel has an apparent gel volume inside the plate from about 5% to about 80%

22. The battery electrode assembly of claim 3 wherein said particulate material effectively reduces a functional pore-size sufficiently to draw in electrolyte via capillary forces.

23. The battery electrode assembly of claim 3 wherein said particulate material size varies from substantially 30 nanometers to substantially 50 microns.

24. The battery electrode assembly of claim 3 wherein said particulate material is an agglomerate.

25. The battery electrode assembly of claim 24 wherein said agglomerate has a primary particle size from substantially 1 nanometer to substantially 5 microns.

26. The battery electrode assembly of claim 24 wherein said agglomerate has a small dimension of at least about 200 nanometers.

27. The battery electrode assembly of claim 24 wherein said agglomerate has at least one dimension of about 1/50th of a window dimension.

28. The battery electrode assembly of claim 3 wherein said particulate material has particles that are reticulated, star-shaped, or round.

29. The battery electrode assembly of claim 3 wherein said particulate material is a fiber having a smaller dimension from about 30 nanometers to about 20 microns.

30. The battery electrode assembly of claim 3 wherein said particulate material is a fiber having a length from about 200 nanometers to about 50 microns.

31. The battery electrode assembly of claim 1 wherein a spacing between a plurality of large pores is about ½ a plate thickness.

32. The battery electrode assembly of claim 1 wherein a large pore diameter is about ¼ a plate thickness.

33. The battery electrode assembly of claim 3 wherein a primary particle size of about 30 nanometers is agglomerated into agglomerates about 1 micron to about 2 microns in size.

34. The battery electrode assembly of claim 1 wherein a high-rate capacity is about 15 to 20% higher than a battery electrode without pore inserts.

35. The battery electrode assembly of claim 1 wherein a high-rate capacity remains stable for at least about 100 hundred discharge/charge cycles.

36. The battery electrode assembly of claim 1 wherein output capacity increase over a battery electrode without pore inserts by about 50%, and the increased output is maintained for discharge rates of at least C/2.5.

37. The battery electrode assembly of claim 1 wherein an output amp level is maintained with less than a 100% recharge.

38. The battery electrode assembly of claim 3 wherein said electrode is made by suspending particles in a slurry of roughly 10% volume of particles, said slurry being then wash-coated, vacuum impregnated, or sprayed into the open pores of the electrode plates, followed by drying.

39. The battery electrode assembly of claim 1 further comprising;
a compact battery of a lead acid type, said battery comprising:
a first cell, said cell being comprised of at least one first negative plate with at least one first negative tab, said first negative tab being oriented in a first direction; and a first positive plate with a first positive tab, said first positive tab being oriented in a second direction;
a second cell, said second cell being comprised of at least one second negative plate, with at least one second negative tab, said second negative tab being oriented in said second direction and at least one second positive plate, said second positive plate having a second positive tab, said second positive tab being oriented in said first direction;
a case, said first cell and said second cell being disposed in said case, such that said first negative tabs of said first cell is substantially adjacent said second positive tab of said second cell along said first direction;
an intercell connection between said first negative tabs and said second positive tabs.

40. A compact battery of a lead acid type, said battery comprising:
a first cell, said cell being comprised of at least one first negative plate with at least one first negative tab, said first negative tab being oriented in a first direction; and a first positive plate with a first positive tab, said first positive tab being oriented in a second direction;
a second cell, said second cell being comprised of at least one second negative plate, with at least one second negative tab, said second negative tab being oriented in said second direction and at least one second positive plate, said second positive plate having a second positive tab, said second positive tab being oriented in said first direction;
a case, said first cell and said second cell being disposed in said case, such that said first negative tabs of said first cell is substantially adjacent said second positive tab of said second cell along said first direction;
an intercell connection between said first negative tabs and said second positive tabs.

41. The battery of claim 40 further comprising at least one separator between at least two of said plates.

42. The battery of claim 40 wherein said first positive tab and said second negative tab are disposed to be in operative communication with a respective negative and positive terminals extending outside said case.

43. The battery of claim 40 wherein said intercell connection has a width, said width being substantially equal to or less than a combined width of said first cell and said second cell.

44. The battery of claim 40 wherein said battery is a 4 Volt, 2-cell lead acid battery.

45. The battery of claim 40 further comprising a battery electrode assembly comprising:
a porous electroplate having a plurality of pores;
a gelled electrolyte, said gelled electrolyte being maintained within a plurality of said pores.

46. The battery of claim 40 further comprising a battery electrode assembly comprising:
a porous electroplate, having a plurality of pores, a volume of particulate material, said particulate material being comprised of particles having outside diameters of less than 50 microns, said particulate material being within a plurality of said pores, said plurality of pores in which said particulate material is maintained having an inside minor diameter of at least about 50 microns.
